(19) United States
(12) Patent Application Publication
(10) Pub. No.: US 2013/0301700 A1
(43) Pub. Date: Nov. 14, 2013

(54) VIDEO ENCODING DEVICE AND ENCODING METHOD THEREOF

(71) Applicant: SAMSUNG ELECTRONICS CO., LTD., Suwon-si (KR)

(72) Inventors: Nyeongkyu KWON, Daejeon (KR); Hyukjae JANG, Suwon-si (KR)

(73) Assignee: SAMSUNG ELECTRONICS CO., LTD., Suwon-si (KR)

(21) Appl. No.: 13/803,500

(22) Filed: Mar. 14, 2013

(30) Foreign Application Priority Data
May 8, 2012 (KR) 10-2012-0048708

(51) Int. Cl. H04N 7/26

(52) U.S. Cl. CPC H04N 19/00169
USPC 375/240.02

(57) ABSTRACT

A video encoding device includes a codec unit to encode first image data to be output as a bitstream and to generate a rate control signal according to a result of the encoding and a pre-processor to perform a decimation operation on second image data successive to the first data and to transmit the second image data to the codec unit.

### CROSS-REFERENCE TO RELATED APPLICATIONS

This U.S. non-provisional patent application claims priority under 35 U.S.C. §119 to Korean Patent Application No. 10-2012-0048708, filed on May 8, 2012, the entirety of which is hereby incorporated by reference.

### BACKGROUND OF THE INVENTION

1. Field of the Invention

The present general inventive concept relates to an image data processing system, and more particularly, to a video encoding device to decrease an amount of image data and a video encoding method thereof.

2. Description of the Related Art

A number of different video encoding standards have been established for encoding image data. The Moving Picture Experts Group (MPEG), for example, has developed a number of standards including MPEG-1, MPEG-2 and MPEG-4. Other video encoding standards include the International Telecommunication Union (ITU) H.263 and ITU H.264/AVC standards. These video encoding standards improve transmission efficiency of image data by encoding the image data in a compression scheme.

In case of wireless data transmission in mobile devices such as smart phones which have been rapidly spread in recent years, a low bandwidth is generally required due to limitation in transmission channel band. In order to meet the condition of low bandwidth, a video encoding system adjusts quantizing parameters of an image signal. However, even under the condition, a temporary bitrate may exceed the channel bandwidth even when the maximum quantizing parameter is set according to the size of input data. This phenomenon is called bitrate overshoot. Reality is that the bitrate overshoot is not sufficiently overcome only by adjusting quantizing parameters in a codec.

Accordingly, there is a need for an image data encoding technique which is capable of overcoming a bitrate overshoot problem.

### SUMMARY OF THE INVENTION

Embodiments of the inventive concept provide a video encoding device and an image data encoding method.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a video encoding device including a codec unit to encode image data to be output as a bitstream and to generate a rate control signal according to a result of the encoding, and a pre-processor to perform a decimation operation on second image data successive to the first image data and to transmit the second image data to the codec unit.

The foregoing and/or other features and utilities of the present general inventive concept may also be achieved by providing an image data encoding method including encoding input first image data into a bitstream, detecting an amount of data of the bitstream, and decimating second image data successive to the first image data according to a result of the detection.

The foregoing and/or other features and utilities of the present general inventive concept may also be achieved by providing a non-transitory computer-readable medium to contain computer-readable codes as a program to execute the above described method.

The foregoing and/or other features and utilities of the present general inventive concept may also be achieved by providing a video encoding device including a codec unit configured to perform an encoding operation on first image data and second image data to output a first bitstream and a second bitstream, respectively, through a bandwidth channel, and a pre-processor configured to selectively perform a decimation operation on at least one of the first image data and the second image data to be output to the codec unit.

The codec unit may generate a signal representing a comparison between the encoded first image data and a reference, and the pre-processor may perform the decimation operation according to the signal.

A first number of bits of the encoded first image data may be smaller than a first reference number of bits of the bandwidth channel. A second number of bits of the encoded second image data may be smaller than a second reference number of bits of the bandwidth channel.

The foregoing and/or other features and utilities of the present general inventive concept may also be achieved by providing an electronic apparatus including the above described video encoding device, and a display unit to display an image corresponding to the bitstream.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating a video encoding device according to an embodiment of the inventive concept.

FIG. 2 is a graphic diagram illustrating an effect according to an embodiment of the inventive concept.

FIG. 3 is a flowchart illustrating an image data processing method according to an embodiment of the inventive concept.

FIG. 4 is a block diagram illustrating a video encoding device according to an embodiment of the inventive concept.

FIG. 5 is a flowchart illustrating an image data processing method using the video encoding device of FIG. 4 according to an embodiment of the present general inventive concept.

FIG. 6 is a block diagram illustrating a video encoding device according to an embodiment of the inventive concept.

FIG. 7 is a flowchart illustrating an image data processing method using the video encoding device of FIG. 6 according to an embodiment of the present general inventive concept.

FIG. 8 is a flowchart illustrating a Chroma subsampling operation of FIG. 7.

FIG. 9 is a block diagram illustrating a video encoding device according to an embodiment of the inventive concept.

FIG. 10 is a flowchart illustrating an image data processing method using the video encoding device of FIG. 9 according to an embodiment of the present general inventive concept.

FIG. 11 is a flowchart illustrating a pre-processing operation of FIG. 10.

FIG. 12 is a block diagram illustrating a mobile terminal according to an embodiment of the inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. It should be noted, however, that the inventive concept is not limited to the following exemplary embodiments, and may be implemented in various forms. Accordingly, the exemplary embodiments are provided only to disclose examples of the inventive concept and to let those skilled in the art understand the nature of the inventive concept.

In the specification, it will also be understood that when an element or lines are referred to as being “on” a target element block, it can be directly on the target element block, or intervening another element may also be present. In the drawings, thicknesses of elements are exaggerated for clarity of illustration.

The terms used in the specification are for the purpose of describing particular embodiments only and are not intended to be limiting of the invention. As used in the specification, the singular forms “a”, “an” and “the” are intended to include the plural forms as well, unless the context clearly indicates otherwise. It will be further understood that the terms “comprises” and/or “comprising”, when used in the specification, specify the presence of stated features, integers, steps, operations, elements, and/or components, but do not preclude the presence or addition of one or more other features, integers, steps, operations, elements, components, and/or groups thereof.

Each embodiment described and exemplified herein may include a complementary embodiment thereof. Note that flash memory devices and their basic operations and program and block erase operations will not be described to avoid ambiguity of the feature of the inventive concept.

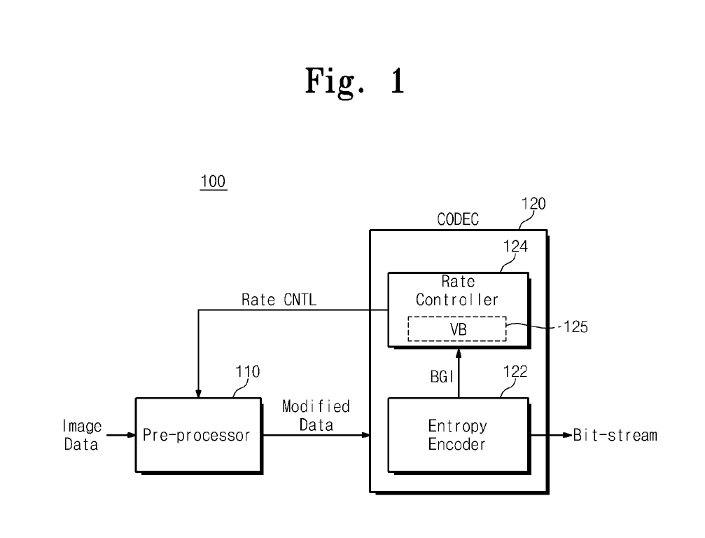

Referring to FIG. 1, a block diagram illustrates a video encoding device 100 according to an embodiment of the inventive concept. The video encoding device 100 includes a pre-processor 110 and a codec (codec unit) 120. The codec 120 includes an entropy encoder 122 and a rate controller 124.

The pre-processor 110 performs a decimation process on image data before arithmetic coding by the codec 120. The pre-processor 110 may perform a scale-down process on input image data with reference to a rate control signal Rate CNTL that is fed back from the codec 120. Hereinafter, these operations performed in the pre-processor 110 will be referred to as a decimation process. The pre-processor 110 may provide image data modified by the decimation process to the codec 120.

The codec 120 encodes the modified data and outputs a bitstream as a result of the encoding. A procedure of encoding image data by the codec 120 is as follows. The codec 120 processes the modified data through discrete cosine transform (DCT) computation. The codec 120 quantizes data generated by the DCT computation. The quantized data may be output as a bitstream through variable length coding (hereinafter referred to as “VLC”).

In the codec 120, inverse quantization and inverse DCT (IDCT) are performed on the quantized data. The image restored through the above procedure is stored in an internal memory (not illustrated). The code 120 generates a motion vector using the restored image stored in the internal memory and a subsequently input frame image. The motion vector is processed in a manner of variable length coding (VLC). The VLC-processed motion vector may constitute a bitstream with encoded image data before being transmitted. Image decoding may be conducted in the reverse order of the foregoing encoding procedure.

As described above, the codec 120 includes the entropy encoder 122 and the rate controller 124. The entropy encoder 122 applies VLC computation to quantized data to output a bitstream as a result of the VLC computation. The entropy encoder 122 may process quantized data according to algorithms such as arithmetic coding, Huffman coding, run-length coding, and Lempel Ziv (LZ) coding.

The rate controller 124 receives bit generation information (hereinafter referred to as “BGI”) provided from the entropy encoder 122. The rate controller 124 may control the pre-processor 110, with reference to the BIG, considering the number of bits generated by the entropy encoder 122 and the number of bits transmitted through a channel band (target bits). That is, the rate controller 124 generates a rate control signal Rate CNTL such that a value obtained by subtracting the number of the target bits from the number of generated bits does not exceed a threshold. In order to perform this operation, the rate controller 124 may include a virtual buffer 125 to monitor a bitrate situation.

According to an embodiment of the inventive concept, a bitrate overshoot may be effectively blocked or prevented (the bitrate overshoot is a phenomenon where the number of instantly generated bits exceeds a maximum channel bandwidth). This is because the amount of data may be adaptively reduced according to a state of a channel before image data is provided to the codec 120. It is possible that a bitrate overshoot problem may not be overcome or avoidable only by adjustment of a quantization parameter (hereinafter referred to as “QP”) conducted in the codec 120. In this case, the bitrate overshoot problem may be solved or prevented through an image data decimation process performed by the pre-processor 110.

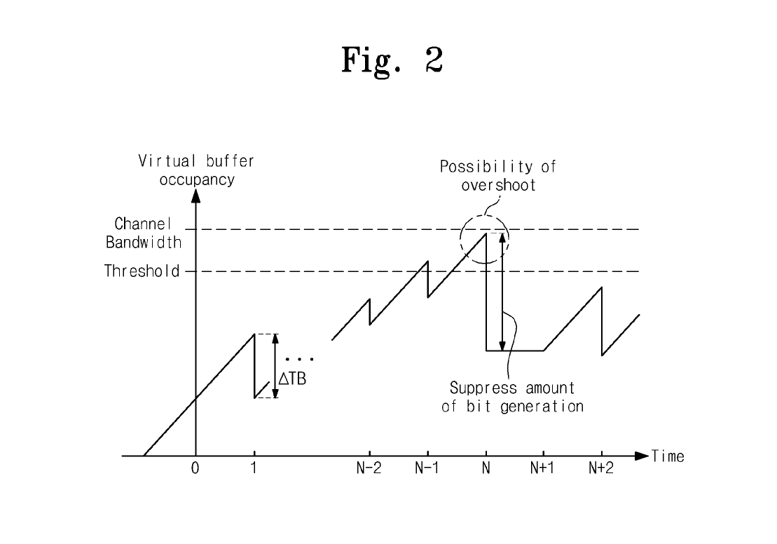

Referring to FIG. 2, a graphic diagram illustrates an effect of a bitrate overshoot problem and a reduced bit amount according to an embodiment of the inventive concept. The graphic diagram of FIG. 2 also illustrates a state of a virtual buffer 125 managed by the rate controller 124 of FIG. 1.

Referring to FIGS. 1 and 2, first image data may be input to the pre-processor 110. However, an output corresponding to the first input data may not efficiently exceed a channel bandwidth due to a QP adjusting operation set in the codec 120. For example, image data input at a time “1” may be transmitted to a channel as many as the number of bits ΔTB (target bits) corresponding to a target bitrate (e.g., 1000 bps). However, when the number of input bits increases with the lapse of time or with the increased number of input frames, the number of bits generated by an entropy encoder 122 may increases. In a certain case, the increased number of the generated bits cannot be managed according to a bandwidth of a channel. This point of time is illustrated as a time “N.”

At the point of time N, if the number of the bits generated by the entropy encoder 122 is greater than target bits transmittable to a channel, there is a high probability that a bitrate overshoot occurs. Thus, the virtual buffer 125 allows the rate controller 124 to count the bit generation information and monitor the point of time when a bitrate overshoot may occur.

When the rate controller 124 is in a situation where a bitrate overshoot may occur, the rate controller 124 generate a control signal to instruct the pre-processor 110 to perform a decimation operation on input image data. The situation where a bitrate overshoot may occur may be set as a situation determined when the predetermined number of bit counts of the virtual buffer 125 is about to exceed or exceeds a threshold. The situation may be determined according to an increasing ratio of the generated bits or an increasing speed of the generated bits. It is possible that that the situation may be determined when the generated bits are in between the threshold and the channel bandwidth. It is also possible that the situation may be a situation when the generated bits approach the threshold or when the generated bits becomes more than the threshold. It is possible that the satiation may be determined according to a comparison between the generated bits and at least one of threshold and a channel bandwidth. The pre-processor 110 may perform a decimation process on image data in response to the control signal of the rate controller 124.

The decimation operation on input image data may include decimating input image data which is less significant data among the input image data. The less significant data may be data corresponding to a less sensitively recognized portion by human vision. An example of the decimation operation is bit precision reduction. However, the present general inventive concept is not limited thereto. It is possible that the decimation operation may be Chroma subsampling. It is also possible that various bit decimation concepts may be applied to the decimation operation.

Due to the decimation operation, the number of bits of bitstream generated by subsequently input image data if prevented from being increased at a point of time (N+1). Thus, bit decimation of the image data input to a codec may allow the number of bits counted to the virtual buffer 125 to rapidly decrease and allow a probability of bitrate overshoot occurrence to be significantly reduced.

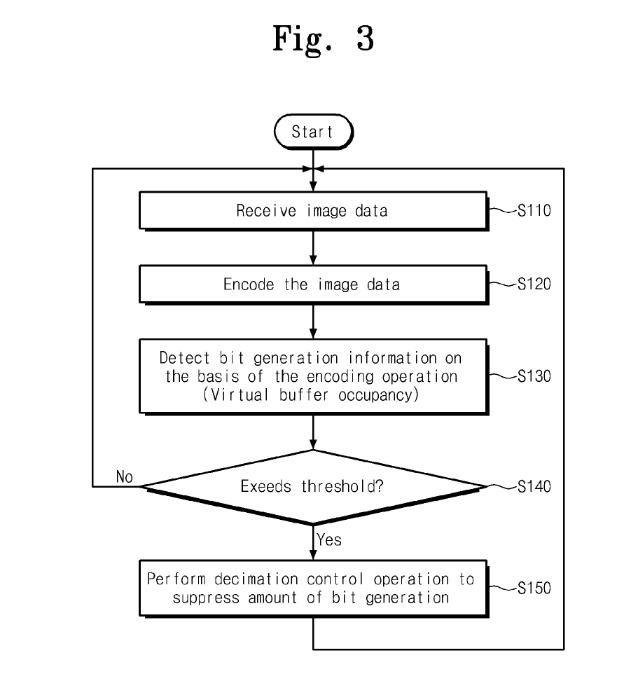

Referring to FIG. 3, a flowchart illustrates an image data processing method according to an embodiment of the inventive concept. In the image data processing method, a video encoding device (for example, the video encoding device 100 of FIG. 1) according to the inventive concept may reduce image data input to a codec (for example, the codec 120 of FIG. 1) according to bit generation information (BGI).

The image data processing method will now be described in detail with reference to FIGS. 1 and 3.

At operation S110, the pre-processor 110 receives image data, for example, sensed image data. The pre-processor 110 may perform a decimation operation on the received image data according to the control of the rate controller 124 of the codec 120. However, in a case of a first pixel in a frame to which the image data is transmitted, the pre-processor 110 may bypass the image data to output the bypassed image data to the codec 120. That is, the pre-processor 110 may transmit the image data to the codec 120 without the decimation operation when a rate control signal Rate CNTL remains inactive. It is possible that the pre-processor 110 may process the image data without performing the decimation operation and then may transmit the processed image data to the codec 120.

At operation S120, the codec 120 encodes the image data. And the codec 120 outputs a bitstream as a result of the encoding. A procedure of encoding the image data by the codec 120 is as follows. The codec 120 processes modified image data through discrete cosine transform (hereinafter referred to as “DCT”). The codec 120 quantizes the discretely cosine-transformed image data. The quantized data may be processed in the manner of variable length coding (hereinafter referred to as “VLC”) and output as a bitstream.

At operation S130, the rate controller 124 monitors sizes of bits generated in the entropy encoder 122 in response to the bit generation information BGI provided from the entropy encoder 122. The rate controller 124 monitors, for example, a generated bit and a target bit counted to the virtual buffer 125. The rate controller 124 may monitor whether a virtual buffer occupancy (VBO) counted to the virtual buffer 125 exceeds a threshold.

At operation S140, the rate controller 124 compares the VBO indicating a size of the generated bit with a threshold. When the VBO does not exceed the threshold, the flow returns to the operation S110 to receive the next image data. On the other hand, when the VBO exceeds the threshold, the flow proceeds to operation S150 to perform the image data decimation by the pre-processor 110.

At the operation S150, the rate controller 124 provides a control signal to the pre-processor 110 to decrease the number of generated bits. The pre-processor 110 performs a decimation operation on subsequently input image data (e.g., pixel data) in response to the control signal of the rate controller 124. Due to the pre-processor 110, the image data may be transmitted to the codec 120 while being partially decimated.

Depending on the degree of generation of image data currently encoded according to the above operations, it is determined whether a decimation operation is performed on subsequently input image data. Thus, a bitrate overshoot may be prevented or avoidable according to a size of the decimated image data provided to the codec 120 within limited channel bandwidth. It is possible that the decimation operation is performed to prevent or avoid the bitrate overshoot problem. It is also possible that the decimation operation and the QP adjusting operation may be performed to prevent or avoid the bitrate overshoot problem.

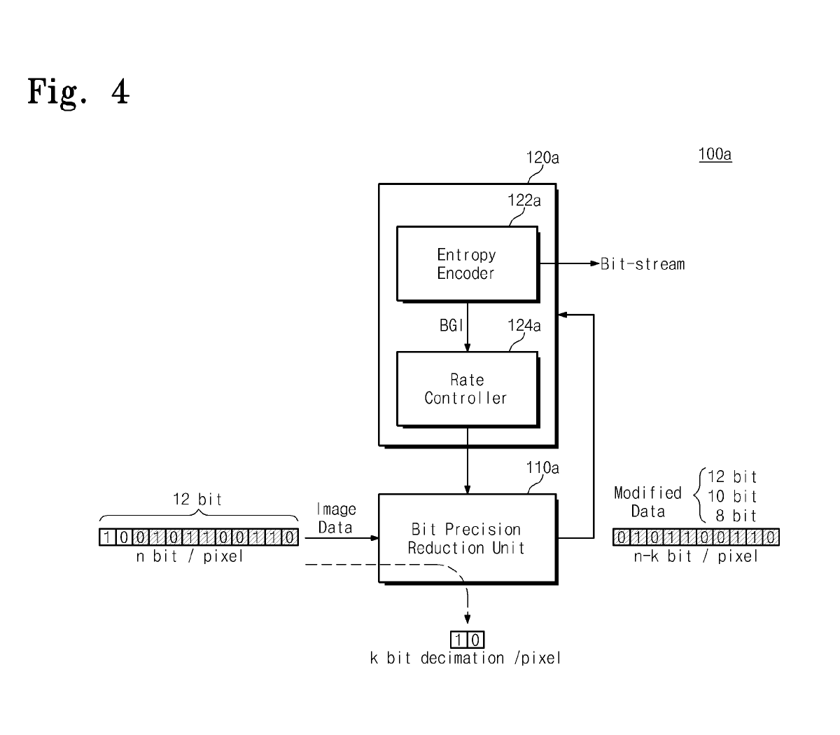

Referring to FIG. 4, a block diagram illustrates a video encoding device 100a according to an embodiment of the inventive concept. The video encoding device 110 includes a bit precision reduction unit 110a and a codec 120a. As described above, the codec 120a includes an entropy encoder 122a and a rate controller 124a.

The bit precision reduction unit 110a may perform a bit precision reduction operation on input image data before the codec 120a performs an encoding operation. The bit precision reduction unit 110a activates or deactivates a bit precision reduction operation on the input image data according to the control of the rate controller 124a of the codec 120a. If the rate controller 124a controls the bit precision reduction unit 110a to activate the bit precision reduction operation, the bit precision reduction unit 110a may decimate some of the input image data.

When input image data is n bits of data corresponding to a single pixel. When the bit precision reduction operation is activated by the rate controller 124a, the bit precision reduction operation may include decimating k bits of least significant bit (LSB) data from the n bits of pixel data. The rate controller 124a may transmit (n−k) bits of image data to the codec 120a. For example, if two bits of LSB (‘01’) are decimated from 12 bits of pixel data (011001101001), ten bits of pixel data (0110011010) may be provided to the codec 120a.

When the input pixel data is 12 bits, data output by the bit precision reduction operation may be set to 12 bits, 10 bits, 8 bits, and so forth. However, if the bit precision reduction operation performed by the rate controller 124a is deactivated, the bit precision reduction unit 110a may bypass a processing on the pixel data to be output to the codec 120a without additionally processing on n bits of the pixel data. Another example of the bit precision reduction operation of the bit precision reduction unit 110a is dithering. Therefore, an overall operation of forcibly decimating LSB from the provided pixel data corresponds to the dithering. the bit precision reduction unit 110a may output modified data (modified image data) to the codec 120a.

The codec 120a encodes the modified image data and outputs a bitstream as a result of the encoding operation. A procedure of encoding image data by the codec 120a is as follows. The codec 120a processes the modified image data through discrete cosine transform (DCT). The codec 120a quantizes the discretely cosine-transformed data. The quantized data may be output as a bitstream through variable length coding (VLC). Since functions of a codec have been previously explained in FIG. 1, detail descriptions thereof will be omitted.

The rate controller 124a may control an operation of decimating image data of the bit precision reduction unit 110a or a degree of decimation of the image data by using bit generation information (BGI) provided from the entropy encoder 122a.

According to the embodiment of the inventive concept, the amount of image data may be reduced before the image data is provided to the codec 120a. Thus, the video encoding device 100a may overcome a bitrate overshoot problem that may not be managed only with quantization parameter (QP) conducted in the codec 120a.

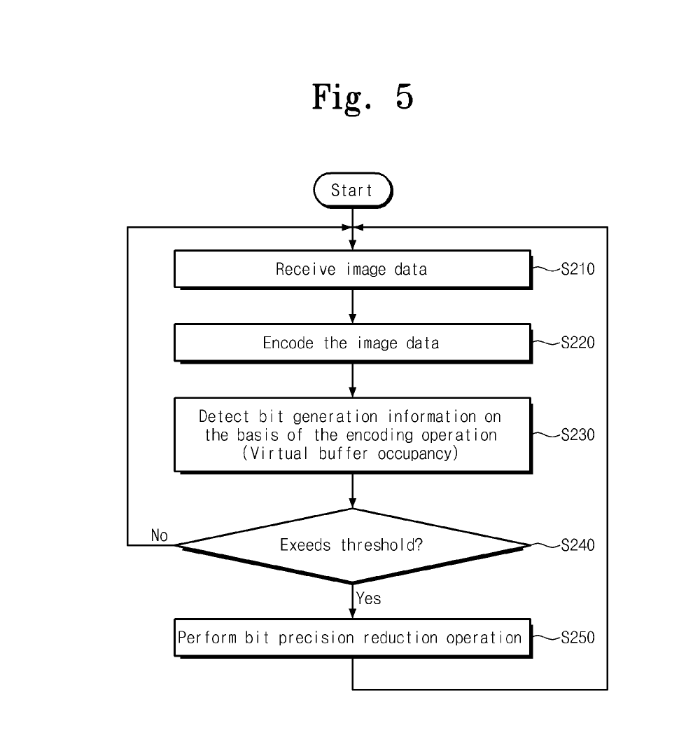

Referring to FIG. 5, a flowchart illustrates an image data processing method using the video encoding device 100a of FIG. 4 according to an embodiment of the present general inventive concept. The video encoding device 100a may reduce bit precision of image data input to the codec 120a with reference to bit generation information (BGI) to secure a bandwidth margin of a channel.

The image data processing method will now be described in detail with reference to FIGS. 4 and 5.

At operation S210, image data provided from image sensing means is provided to the bit precision reduction unit 110a. The bit precision reduction unit 110a may perform a decimation operation on the received image data according to the control of the rate controller 124a of the codec 120a. However, when the image data is a first pixel in a single frame, the bit precision reduction unit 110a may bypass or transmit the image data to the codec 120a without the decimation operation.

At operation S220, the codec 120a encodes the received image data. The codec 120a outputs a bitstream as a result of the encoding operation. A procedure of encoding the image data by the codec 120a is as follows. The codec 120a processes modified image data through discrete cosine transform (DCT). The codec 120a quantizes the discretely cosine-transformed image data. The quantized data may be processed in the manner of variable length coding (VLC) to be output as a bitstream.

At operation S230, the rate controller 124a monitors sizes of bits generated in the entropy encoder 122a with reference to the bit generation information (BGI) provided from the entropy encoder 122a. The rate controller 124a may monitor, for example, variation of a generated bit and an output bit counted to a virtual buffer. The rate controller 124a may monitor whether a virtual buffer occupancy (VBO) counted to the virtual buffer exceeds a threshold.

At operation S240, the rate controller 124 compares the VBO indicating a size of the generated bit with a threshold. When the VBO does not exceed the threshold, the flow returns to the step S210 to receive the next image data. On the other hand, when the VBO exceeds the threshold, the flow proceeds to step S250 to perform image data decimation by the pre-processor 110a.

At the operation S250, the rate controller 124a provides a control signal to the bit precision reduction unit 110a to decrease the number of generated bits. The bit precision reduction unit 110a performs a decimation operation on subsequently input image data (e.g., pixel data) in response to the control signal of the rate controller 124a. Due to the bit precision reduction unit 110a, the image data may be transmitted to the codec 120a while being partially decimated.

Depending on the degree of generation of image data currently encoded according to the above operations, it is determined whether a bit precision reduction operation is performed on subsequently input image data. Thus, the modified image data provided to the codec 120a may have a size to generate a bitstream within a limited channel bandwidth.

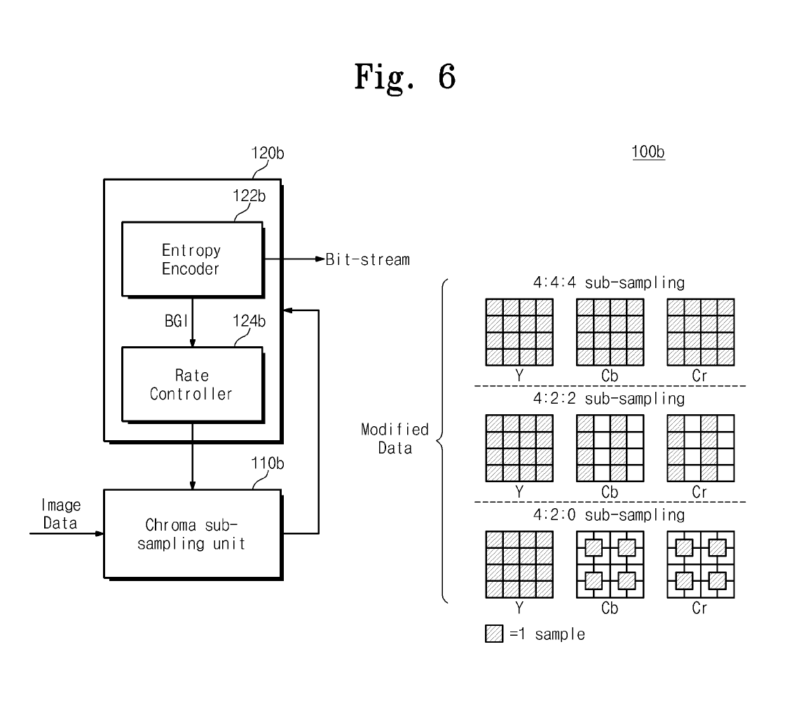

Referring to FIG. 6, a block diagram illustrates a video encoding device 100b according to an embodiment of the inventive concept. The video encoding device 100b includes a Chroma subsampling unit 110b and a codec 120b. As explained above, the codec 120b includes an entropy encoder 122b and a rate controller 124b.

The Chroma subsampling unit 110b performs a subsampling operation on input image data before encoding carried out by the codec 120b. The Chroma subsampling unit 110b activates or deactivates a subsampling operation on the input image data according to the control of the rate controller 124b of the codec 120b. If the rate controller 124b controls the Chroma sampling unit 110b to activate the subsampling operation, the Chroma subsampling unit 110b may subsample Chroma elements (chrominance component) of the input image data. Data of a Chroma element less visually sensitive to the subsampling may be decrease in size.

The operation of the Chroma subsampling operation will now be described hereinafter. When the rate controller 124b activates a subsampling operation on input image data, the Chroma subsampling unit 110b may perform one of various types of subsampling modes. The Chroma subsampling unit 110b may perform, for example, 4:4:4 (YCrCb) subsampling on the input image data. A manner of subsampling may be expressed as three rates. One rate indicates a size of vertical sampling for a Luma element (luminance component or Y), another rate indicates a size of horizontal sampling for Chroma component (Cr), and the other rate indicates a size of horizontal sampling for Chroma element (Cb). The sizes of sampling for the Chroma elements (Cr and Cb) may be relative to the size of sampling for the Luma component (Y).

According to the 4:4:4 subsampling, sampling speeds of the Luma element (Y) and the Chroma elements (Cr and Cb) are equal to each other. In the manner of 4:4:4 subsampling, each of the sampling speeds of the Chroma elements (Cr and Cb) is equivalent to half the sampling speed of the Luma element (Y). That is, each of the Chroma elements (Cr and Cb) may be provided with one-time sampling per two pixels. When the image data input by the Chroma subsampling unit 110b is processed with Chroma subsampling, a size of the image data may be significantly reduced.

However, when the Chroma subsampling operation performed by the rate controller 124b is deactivated, the Chroma subsampling unit 110b may bypass the image data to the codec 120b without subsampling the image data.

Since codec 120b is substantially identical to the codec 120 in FIG. 1 or the codec 120a in FIG. 4, detail descriptions thereof will be omitted.

According to the embodiment of the inventive concept, before image data is provided to the codec 120b, the amount of the image data may be adaptively reduced to overcome a bitrate overshoot problem that may not be managed only with quantization parameter (QP) conducted in the codec 120b.

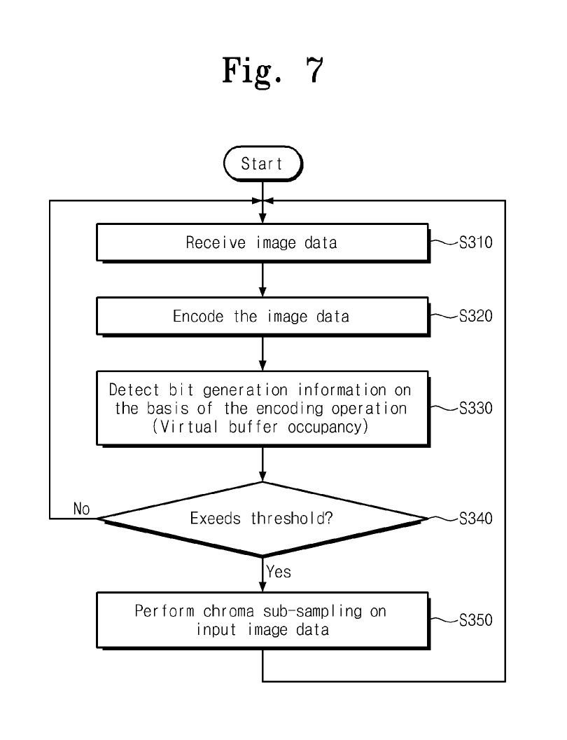

FIG. 7 is a flowchart illustrating an image data processing method using the video encoding device 100b of FIG. 6 according to an embodiment of the present general inventive concept. The video encoding device 100b may secure a bandwidth margin of a channel through Chroma subsampling on image data input to the codec 120b according to bit generation information (BGI).

The image data processing method will now be described in detail with reference to FIGS. 6 and 7.

At operation S310, image data provided from an image sensor is provided to the Chroma subsampling unit 110b. The Chroma subsampling unit 110b decimates the image data according to the control of the rate controller 124b of the codec 120b. However, when image data is a first pixel in a single frame, the Chroma subsampling unit 110b may bypass the image data to the codec 120b without performing a decimation operation on the image data.

At operation S320, the codec 120b encodes the image data. The codec 120b outputs a bitstream as a result of the encoding operation. A procedure of encoding the image data by the codec 120 is as follows. The codec 120b processes modified image data through discrete cosine transform (DCT). The codec 120b quantizes data generated through the DCT. The quantized image data is processed in a manner of variable length coding (VLC) by the entropy encoder 122b. The VLC-processed image data may be output as a bitstream.

At operation S330, the rate controller 124b monitors sizes of bits generated in the entropy encoder 122b with reference to bit generation information (BGI) provided from the entropy encoder 122b. The rate controller 124b monitors, for example, variation of a generated bit and an output bit counted to a virtual buffer. The rate controller 124b may monitor whether a virtual buffer occupancy (VBO) counted to the virtual buffer exceeds a threshold.

At operation S340, the rate controller 124b compares the VBO indicating a size of the generated bit with a threshold. If the VBO does not exceed the threshold, the flow returns to the step S310. If the VBO exceeds the threshold, the flow proceeds to step S350 to decimate the image data by the Chroma subsampling unit 110b.

At operation S350, the rate controller 124b provides a control signal to the Chroma subsampling unit 110b to decrease the number of generated bits. The Chroma subsampling unit 110b performs a Chroma subsampling operation on subsequently input image data (e.g., pixel data) in response to the control signal of the rate controller 124b. Due to the Chroma sampling unit 110b, the image data may be transmitted to the codec 120b while being partially decimated.

Depending on the degree of generation of image data currently encoded according to the above operations, it is determined whether a decimation operation is performed on subsequently input image data. Thus, the modified image data provided to the codec 120b may have a size to generate a bitstream within limited channel bandwidth.

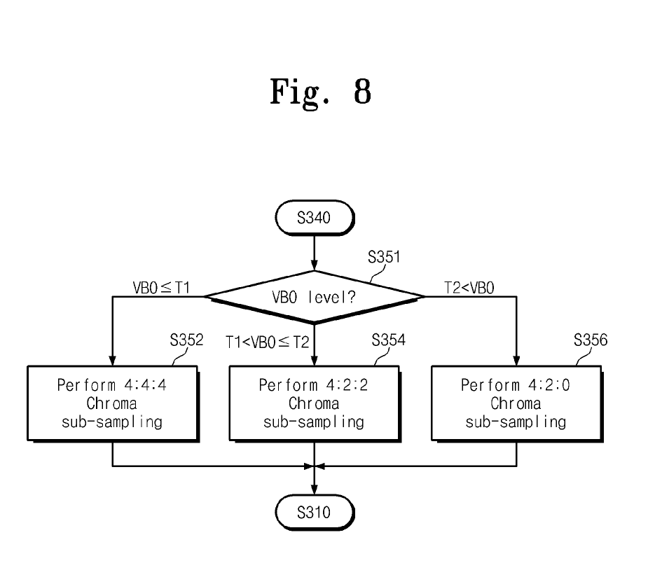

Referring to FIG. 8, a flowchart illustrates the operation S350 of FIG. 7 at which the Chroma subsampling operation is performed. One of a plurality of sampling manners 4:4:4, 4:2:2, and 4:2:0 may be selected according to a virtual buffer occupancy (VBO) detected by the rate controller 124b.

The operation S350 will now be described below in detail with reference to FIGS. 7 and 8.

At operation S351, the rate controller 124b may perform subsampling operations of different sampling rates according to the level of virtual buffer occupancy (VBO). The rate controller 124b detects a size of the VBO indicating a size of a bit generated. If the VBO does not exceed a first threshold T1, the flow proceeds to operation S352 to perform 4:4:4 Chroma subsampling. However, if the VBO is greater than the first threshold V1 and smaller than a second threshold T2, the flow proceeds to operation S354 to perform 4:2:2 Chroma subsampling. If the VBO is greater than the second threshold T2, the flow proceeds to operation S356 to perform 4:2:0 Chroma subsampling.

At the operation S352, the Chroma subsampling unit 110b performs the 4:4:4 Chroma subsampling operation. The 4:4:4 Chroma subsampling operation corresponds to a mode with least data loss among a plurality of Chroma subsampling modes.

At operation S354, the Chroma subsampling unit 110b performs the 4:2:2 Chroma subsampling operation. In the 4:2:2 Chroma subsampling operation, a sampling rate of Chroma elements (Cr and Cb) is equivalent to half the sampling rate of a Luma element (Y).

At operation S356, the Chroma subsampling unit 110b performs the 4:2:0 Chroma subsampling operation. In the 4:2:0 Chroma subsampling operation, the sampling rate of the Chroma elements (Cr and Cb) is equivalent to a half of the sampling rate of the Luma element (Y). The 4:2:0 Chroma subsampling operation corresponds to a mode with relatively large data loss among a plurality of Chroma subsampling modes. Thus, if the 4:2:0 subsampling is applied to input image data under a worry about bitrate overshoot, a burden of the codec 120b may be significantly alleviated.

When each of the Chroma subsampling operations S352, S354, and S356 is terminated, the flow returns to the operation S310 of FIG. 7 to process new image data. While Chroma subsampling modes corresponding to three different sampling rates have been described, the inventive concept is not limited thereto. It is possible that various Chroma subsampling modes may be applied to the Chroma subsampling operation.

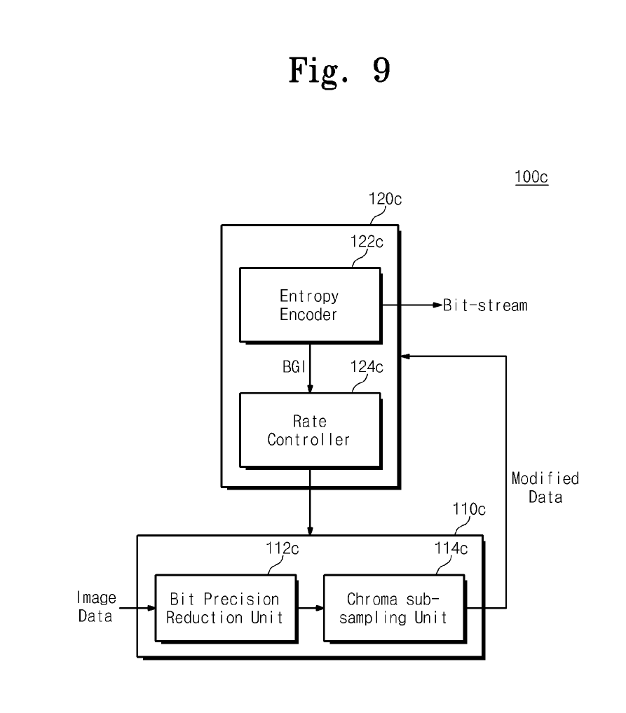

Referring to FIG. 9, a block diagram illustrates a video encoding device 100c according to an embodiment of the inventive concept. The video encoding device 100c includes a pre-processor 110c including a bit precision reduction unit 112c and a Chroma subsampling unit 114c and a codec 120c. As described above, the codec 120c includes an entropy encoder 122c and a rate controller 124c.

The pre-processor 110c includes at least two units to reduce a size of image data to be provided to the codec 120c. Exemplarily, the bit precision reduction unit 112c and the Chroma subsampling unit 114c may be provided as these units. However, it will be understood that the configuration or algorithms for reducing a size of image data in various manners may be complexly driven in the pre-processor 110c. The detailed operations of the bit precision reduction unit 112c and the Chroma subsampling unit 114c have been described in the foregoing embodiments and will not be described in further detail.

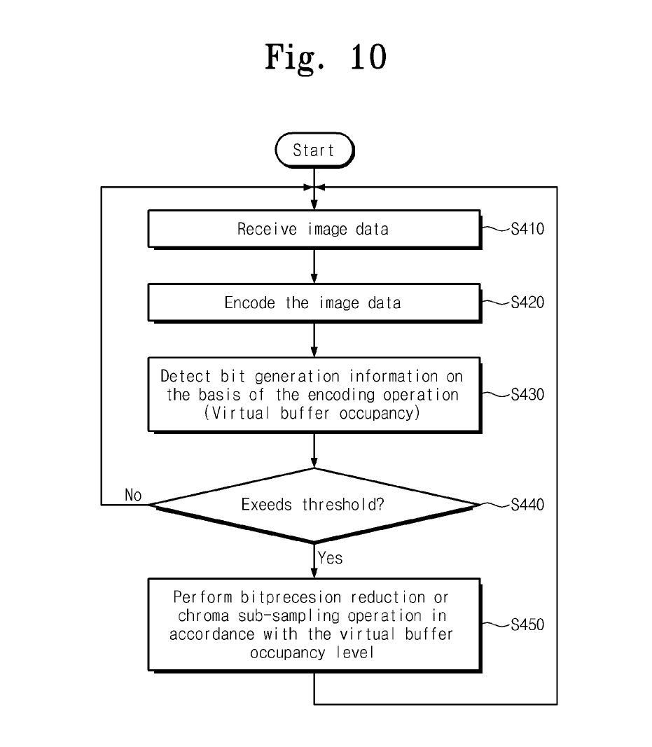

The rate controller 124c controls the pre-processor 110c using bit generation information (BGI) provided from the entropy encoder 122c. The rate controller 124c may activate at least one of a plurality units incorporated in the pre-processor 110c with reference to the bit generation information (BGI). For example, if it is determined that a size of generated bit increases rapidly, the rate controller 124c may concurrently activate the bit precision reduction unit 112c and the Chroma subsampling unit 114c. Meanwhile, the rate controller 124c may activate only one of a plurality of units incorporated in the pre-processor 110c. The above operation of the rate controller 124c will be described in detail with reference to FIGS. 10 and

According to the embodiment of the inventive concept, before image data is provided to the codec 120c, the amount of the image data may be adaptively reduced to overcome a bitrate overshoot problem that may not be managed only with quantization parameter (QP) conducted in the codec 120c.

Referring to FIG. 10, a flowchart illustrates an image data processing method using the video encoding device 100c of FIG. 9. In FIGS. 9 and 10, the video encoding device 100c may perform various levels of decimation operations on image data input to the codec 120c according to bit generation information (BGI).

At operation S410, image data provided from image sensing means is provided to the pre-processor 110c. The pre-processor 110c may decimate the received image data according to the control of the rate controller 124c of the codec 120c. However, the pre-processor 110c may bypass image data to the codec 120 without performing the decimation operation when the image data is a first pixel in a single frame.

At operation S420, the codec 120c encodes the received image data. The codec 120c outputs a bitstream as a result of the encoding. The codec 120c performs variable length coding (VCL) on quantized data through the entropy encoder 122c. By the entropy encoder 122c, the image data is output as a bitstream. At this point, bit generation information (BGI) generated by the encoding operation is provided to the rate controller 124c.

At operation S430, the rate controller 124c monitors sizes of bits generated in the entropy encoder 122c with reference to the bit generation information (BGI) provided from the entropy encoder 122c. The rate controller 124c monitors, for example, variation of a generated bit and an output bit counted to a virtual buffer. The rate controller 124c may monitor whether a virtual buffer occupancy (VBO) counted to the virtual buffer exceeds a threshold.

At operation S440, the rate controller 124c compares the VBO indicating a size of the generated bit with the threshold. If the VBO does not exceed the threshold, the flow returns to the operation S410 to receive the next image data. Meanwhile, if the VBO exceeds the threshold, the flow proceeds to operation S450 to decimate the image data by the pre-processor 110c.

At operation S450, the rate controller 124c provides a control signal to the pre-processor 110c to decrease the number of generated bits. The rate controller 124c may activate both or one of the bit precision reduction unit 112c and the Chroma subsampling unit 114c according to the size of the VBO.

Depending on the degree of generation of image data currently encoded according to the above operations, it is determined whether a bit precision reduction operation is performed on subsequently input image data. Thus, the modified image data provided to the codec 120c may have a size to generate a bitstream within a limited channel bandwidth.

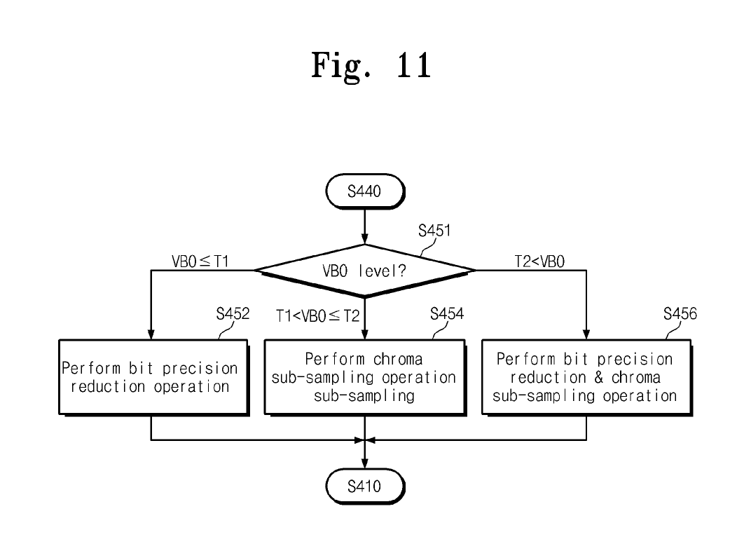

Referring to FIG. 11, a flowchart illustrates the operation S450 corresponding to the pre-processing operation of FIG. 10. In FIG. 11, to procedure of activating one or both of the bit precision reduction unit 112c and the Chroma subsampling unit 114c is performed according to the VBO detected by the pre-processor 110c.

At operation S451, the rate controller 124c may perform subsampling operations of different sampling rates according to the level of the VBO. The rate controller 124b detects a size of the VBO indicating a size of a generated bit. If the VBO does not exceed a first threshold T1, the flow proceeds to operation S452 to perform a bit precision reduction operation. Meanwhile, if the VBO is greater than the first threshold T1 and smaller than a second threshold T2, the flow proceeds to operation S454 to perform a Chroma subsampling operation. If the VBO is greater than the second threshold T2, the flow proceeds to operation S456 perform both the bit precision reduction operation and the Chroma subsampling operation.

At operation S452, the rate controller 124c may activate only the bit precision reduction unit 112c among a plurality of units incorporated in the pre-processor 110c. However, the bit precision reduction unit 112c may provide input image data to the codec 120c after performing a bit precision reduction operation on the input image data. While the step S452 is described as a single step, there may be selected various sizes of bits reduced through a single computation in response itemized levels of the VBO.

At operation S454, the rate controller 124c may only the Chroma subsampling unit 114c among the plurality of units incorporated in the pre-processor 110c. Then, the Chroma subsampling unit 114c may provide input image data to the codec 120c after performing a bit precision reduction operation on the input image data. At the step S454, 4:4:4, 4:2:2, and 4:2:0 Chroma subsampling operations may be selectively performed in response to the itemized levels of the VBO.

At operation S456, the rate controller 124c activates both the bit precision reduction unit 112c and the Chroma subsampling unit 114c among the plurality of units incorporated in the pre-processor 110c. Then, a bit precision reduction operation of image data may be performed by the bit precision reduction unit 112c. The Chroma subsampling unit 114c may provide an output of the bit precision reduction unit 112c to the codec 120c after performing a Chroma subsampling operation on the output of the bit precision reduction unit 112c. It will be understood that the order of the bit precision reduction unit 112c and the Chroma subsampling unit 114c may be changed.

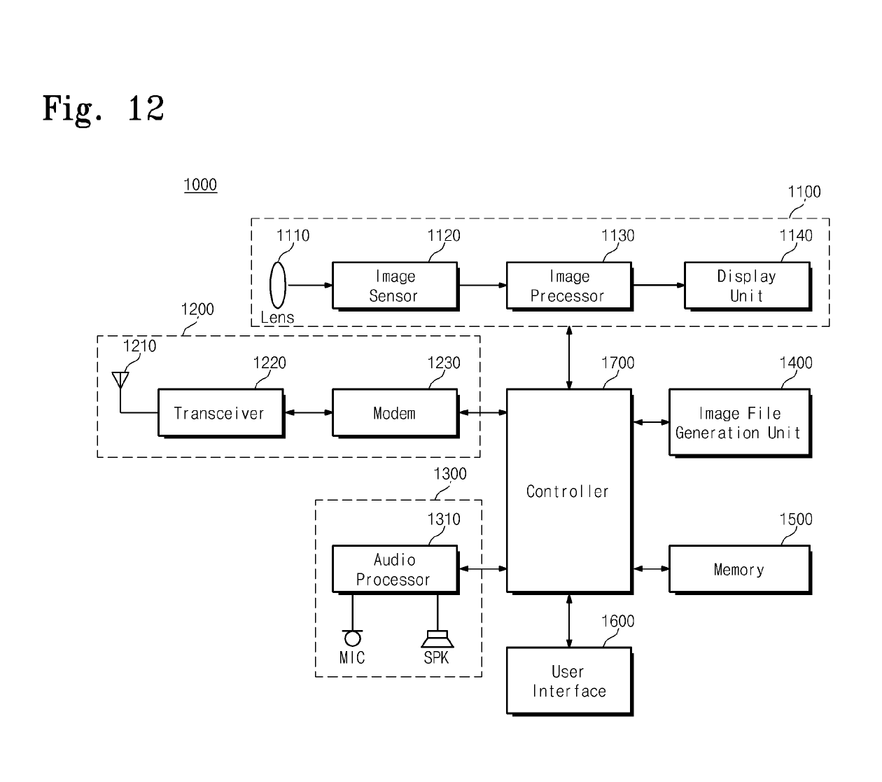

FIG. 12 is a block diagram illustrating an electronic apparatus, such as a mobile terminal 1000, according to an embodiment of the inventive concept. The mobile terminal 1000 includes an image processing unit 1100, a wireless transceiving unit 1200, an audio processing unit 1300, an image file generation unit 1400, a memory 1500, a user interface 1600, and a controller 1700.

The image processing unit 1100 includes a lens 1110, an image sensor 1120, an image processor 1130, a display unit 1140. The wireless transceiving unit 1200 includes an antenna 1210, a transceiver 1220, and a modem 1230. The audio processing unit 1300 includes an audio processor 1310, a microphone MIC to receive sound and to output audio data to the audio processor 1310 such that the audio data can be processed to be usable in the controller 1700 associated with the image processing unit, the image file generation unit 1400, and the memory 1500, and a speaker SPK to output sound corresponding to audio data received from the wireless transeiving unit 1200 or stored in the memory 1500. The image file generation unit may generate data as a file to be output to the display unit 1140, the memory, and/or the wireless transceiving unit 1200. The user interface 1600 communicates with the controller to input a user command or data thereto. The display unit 1140 and the user interface 1600 may be formed as an integrated unit, for example, a touch panel.

The image processing unit 1100 may process image data in any one manner of the above-described embodiments illustrated in FIGS. 1-11. That is, before inputting image data to a codec, the image processor 1130 may perform a pre-process on image data provided from the image sensor 1120 to secure a bandwidth margin of a channel. A pre-processor of the image processor 1130 may include, for example, a bit precision reduction unit or a Chroma subsampling unit. The pre-processor may reduce the amount of image data before inputting the image data to the codec by using a bit precision reduction unit or Chroma subsampling units.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described so far, the amount of image data can be reduced depending on variation of a bitrate before a codec encodes the image data. Thus, a video encoding device according to an embodiment of the inventive concept can overcome a bitrate overshoot problem that may not be managed only with quantization parameter.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A video encoding device usable with an electronic apparatus, comprising:
a codec unit configured to encode first image data to be output as a bitstream and generate a rate control signal according to a result of the encoding; and
a pre-processor configured to perform a decimation operation on second image data successive to the first image data and transmit the second image data to the codec unit.

2. The video encoding device of claim 1, wherein the codec unit activates the decimation operation of the pre-processor when a difference between the number of generated bits of the bitstream and the number of target bits exceeds a reference value.

3. The video encoding device of claim 2, wherein the codec unit comprises a virtual buffer configured to count the number of the generated bits and subtract the number of the transmitted target bits from the number of the generated bits.

4. The video encoding device of claim 1, wherein the pre-processor decimates a portion of the second image data through a bit precision reduction operation or a Chroma subsampling operation in response to the rate control signal.

5. The video encoding device of claim 4, wherein the pre-processor performs the decimation operation and the subtracted number of bits is provided with a plurality of levels according to the rate control signal.

6. The video encoding device of claim 1, wherein the codec unit comprises:
an entropy encoder configured to perform variable length coding on the first image data to output a first stream as the bitstream; and
a rate controller configured to output the rate control signal associated with bit generation information of the entropy encoder.

7. The video encoding device of claim 6, wherein the rate controller comprises a virtual buffer configured to store a value obtained by subtracting the number of target bits transmitted through a channel from the number of generated bits of the entropy encoder.

8. The video encoding device of claim 1, wherein the pre-processor comprises a bit precision reduction unit or a Chroma subsampling unit configured to perform the decimation operation on the second image data.

9. The video encoding device of claim 8, wherein the Chroma subsampling unit performs any one of 4:4:4 subsampling, 4:2:2 subsampling, and 4:2:0 subsampling modes on the second image data.

10. The video encoding device of claim 8, wherein the bit precision reduction unit decimates least significant bits (LSB) such that the second image data corresponding to a single pixel has any one bit precision among 12 bits, 10 bits, and 8 bits.

11. An electronic apparatus comprising:
the video encoding device of claim 1; and
a display unit to display an image corresponding to the bitstream.

12. An image data encoding method of a video encoding device usable with an electronic apparatus, the method comprising:
encoding input first image data into a bitstream;
detecting the amount of data of the bitstream; and
decimating second image data successive to the first image data according to a result of the detection.

13. The image data encoding method of claim 12, further comprising:
providing the decimated second image data to a codec.

14. The image data encoding method of claim 12, wherein the decimating of the second image data comprises reducing a bit precision of the second image data.

15. The image data encoding method of claim 12, wherein the decimating of the second image data comprises performing Chroma subsampling on the second image data.

16. The image data encoding method of claim 12, wherein during the detecting of the amount of data of the bitstream, a virtual buffer occupancy obtained by subtracting the number of transmitted target bits from the number of generated bits of the bitstream is detected.

17. A non-transitory computer-readable medium to contain computer-readable codes as a program to execute the method of claim 12.

18. A video encoding device comprising:
a codec unit configured to perform an encoding operation on first image data and second image data to output a first bitstream and a second bitstream, respectively, through a bandwidth channel; and
a pre-processor configured to selectively perform a decimation operation on at least one of the first image data and the second image data to be output to the codec unit.

19. The video encoding device of claim 18, wherein:
the codec unit generates a signal representing a comparison between the encoded first image data and a reference; and
the pre-processor performs the decimation operation according to the signal.

20. The video encoding device of claim 18, wherein:
a first number of bits of the encoded first image data is smaller than a first reference number of bits of the bandwidth channel; and
a second number of bits of the encoded second image data is smaller than a second reference number of bits of the bandwidth channel.
